(19) United States
(12) Patent Application Publication
(10) Pub. No.: US 2012/0134175 A1
(43) Pub. Date: May 31, 2012

(54) PLANAR LIGHTING DEVICE AND DISPLAY DEVICE HAVING SAME

(75) Inventor: Fumie Kunimasa, Osaka-shi (JP)

(73) Assignee: SHARP KABUSHIKI KAISHA, Osaka-shi, Osaka (JP)

(21) Appl. No.: 13/389,267

(22) PCT Filed: Jul. 7, 2010
(86) PCT No.: PCT/JP2010/061551

§ 371 Date: Feb. 7, 2012

(30) Foreign Application Priority Data
Nov. 30, 2009 (JP) 2009-272741

(51) Int. Cl. G09F 13/18; F21V 8/00

(52) U.S. Cl. 362/602; 362/607

(57) ABSTRACT

Provided are planar lighting device that is excellent in luminance uniformity and light use efficiency and a display device including the planar lighting device. A planar lighting device of the present invention is arranged such that a light guide (22) includes: a first optical member formed on a light incident surface (22a), the first optical member diffusing the light emitted from a light source (21) into the light guide (22); a second optical member formed on a light exit surface (22b) or a back surface (22c), the second optical member changing an angle of the light inside the light guide; a third optical member formed on the light exit surface (22b) or the back surface (22c), the third optical member diffusing the light inside the light guide (22); and a fourth optical member formed on the light exit surface (22b) or the back surface (22c) so as to be close to the light incident surface (22a), the fourth optical member focusing, inside the light guide (22), the light diffused by the first optical member, and the fourth optical member having a concave part set back in the light exit surface (22b) or the back surface (22c).

### TECHNICAL FIELD

The present invention relates to a planar lighting device and a display device including the planar lighting device. More specifically, the present invention relates to a planar lighting device that is excellent in luminance uniformity and light use efficiency and a display device including the planar lighting device.

### BACKGROUND ART

In recent years, liquid crystal display devices, which have spread rapidly to take the place of cathode-ray tubes (CRTs), have been widely used in liquid crystal televisions, monitors, mobile phones, and the like thanks to their energy-saving, low-profile, lightweight features, etc. An example of a method for further exploiting these features is to improve a lighting device (so-called backlights) that is disposed behind a liquid crystal display device.

Lighting devices are classified broadly into edge-light lighting devices (referred to also as “side-light lighting devices”) and direct lighting devices. A direct lighting device is configured to have a plurality of light sources provided behind a liquid crystal display panel so that the liquid crystal display panel is directly irradiated by light. Accordingly, direct lighting devices can easily achieve high luminance even when used for a large screen, and are therefore employed mainly in large-sized liquid crystal displays of 20 inches or larger. However, the existing direct lighting devices are as thick as approximately 20 mm to 40 mm, thus hindering further reductions in thickness of displays.

Meanwhile, an edge-light lighting device is configured to have a light guide (light guide plate) provided behind a liquid crystal display panel and a light source provided on a lateral end of the light guide. A beam of light emitted from the light source is reflected by the light guide to uniformly illuminate the liquid crystal display panel indirectly. This construction makes it possible to realize a lighting device low in luminance but capable of being made thinner and excellent in uniformity of luminance. Therefore, edge-light lighting devices are employed mainly in small-to-medium-sized liquid crystal displays such as those used in mobile phones and laptop computers. However, in a case where a point light source (LED) is used in an edge-light lighting device, it is difficult to uniformly irradiate a wide light guide plate with light.

In view of this, a method of forming a prism (optical member) on a light incident end surface of a light guide so that incident light spreads in a wide range has been conventionally used (see Patent Literatures 1 through 3, for example).

For example, Patent Literature 1 discloses a planar light source device in which an optical pattern 135 such as a prism array is formed on a light incident surface of a light guide plate 122, and a light emitting section (point light source 130) is disposed to face the optical pattern 135, as illustrated in FIG. 23. In the planar light source device disclosed in Patent Literature 1, light emitted from the point light source 130 is diffused by the optical pattern 135 so as to reach even corner sections of the light guide plate 122, thereby improving luminance of the corner sections.

Further, in order to reduce a light loss in an ineffective region in the vicinity of a light entry end surface of a light guide and a light loss from a side surface of the light guide so that light more uniformly enters the light guide, a method is used in which a prism (hairline) extending in a direction substantially vertical to the light entry end surface is formed on a light exit surface or a surface of the light guide which surface faces the light exit surface (see Patent Literatures 2 and 3, for example).

For example, Patent Literature 2 discloses a light guide plate 114 which includes an introducing section 118 for diffusing light emitted from a point light source 115, and a light collecting section 119 (see (a) and (b) of FIG. 24). The light guide plate 114 has (i) a light exit surface 123 from which light having entered the light guide plate 114 from the introducing section 118 is outputted and (ii) a back surface opposite to the light exit surface 123. On the back surface, a reflecting member 124 is formed which reflects, towards the light exit surface 123, light having entered the light collecting section 119 from the point light source 115. On the light exit surface 123, a plurality of prism-shaped ridges 126 are formed so as to extend in a direction vertical to a direction in which a light collecting surface 125a extends.

In the light guide plate disclosed in Patent Literature 2, the light from the point light source 115 is diffused by an optical prism of the introducing section 118 so as to be guided throughout the light guide plate 114. Further, the prism-shaped or lens-shaped ridges 126 are provided on the light exit surface 123 of the light guide plate 114 so as to extend in the direction vertical to an end surface of the light collecting section 119 which end surface faces the introducing section 118. This allows directivity and amount of the light having entered the light collecting section 119 from the introducing section 118 to be made uniform. Consequently, it is possible to (i) suppress occurrence of a dark portion in a part which the point light source 115 faces out of the end surface of the light collecting section 119 which end surface faces the introducing section 118 and (ii) to suppress occurrence of a bright portion in an area between the point light sources 115. Further, the light is reflected, by a reflecting member 121 of the introducing section 118, in a direction substantially vertical to a light entry surface so that the light is guided throughout the light guide plate 114. Consequently, a light loss is reduced.

### CITATION LIST

### Patent Literature 1

Japanese Patent Application Publication, Tokukaihei, No. 10-199316 A (Publication Date: Jul. 31, 1998)

### Patent Literature 2

Japanese Patent Application Publication, Tokukai, No. 2005-63913 A (Publication Date: Mar. 10, 2005)

### Patent Literature 3

Japanese Patent Application Publication, Tokukai, No. 2004-6326 A (Publication Date: Jan. 8, 2004)

### SUMMARY OF INVENTION

### Technical Problem

However, the planar light source device disclosed in Patent Literature 1 has (i) a problem that a light loss occurs in the ineffective region in the vicinity of the point light source 130 due to the light spread by the optical pattern 135 and (ii) a problem that the light goes out from the side surface of the light guide plate 122 and thereby the light loss increases.

Further, the light guide plate 114 disclosed in Patent Literature 2 has a problem that an angle of light spread in a transverse horizontal direction due to the optical pattern formed on the end surface facing the point light source 115 is changed by the prisms formed on the light exit surface 123 so that an angle with respect to the light exit surface 123 becomes smaller than a critical angle, and thereby a light loss becomes large in the vicinity of the point light source 115. Further, in the light guide plate 114 disclosed in Patent Literature 2, light is reflected, by the reflecting surface 121, in a direction substantially vertical to the light incident end surface, but only two reflecting surfaces 121 are provided per point light source, and therefore light entering a portion farther away from the reflecting surface 121 cannot get the effect. Accordingly, an amount of light received by the reflecting surface 121 is undesirably small and therefore the light direction changing effect is low. Further, in the light guide plate 114 disclosed in Patent Literature 2, the notch shape of the reflecting surface 121 can be relatively easily formed by injection molding or the like, but in the case of a producing method of forming a prism on a large sheet and cutting the prism into individual sizes, it is undesirably difficult to form the reflecting surface 121 into a mirror surface.

In a light guide in which a prism extending in a direction substantially vertical to a light incident end surface is formed on a light exit surface or a surface facing the light exit surface, a light loss occurs in an ineffective region (region through which light effective for image displaying does not travel) in the vicinity of the light incident end surface for the following reasons.

In a case where a light incident end surface is not processed into ridges and grooves (not provided with prisms) as illustrated in (a) of FIG. 25, an angular distribution of light having entered a light guide 22 from a light source 21 is within a range of the portion A in (c) of FIG. 25. (c) of FIG. 25 shows the angular distribution of the light in a direction (z-direction) vertical to the light incident end surface. Meanwhile, in a case where the light incident end surface is provided with prisms 1 that extend in a thickness direction of the light guide as illustrated in (b) of FIG. 25, the angular distribution can be expanded to a range shown by the portion B in (c) of FIG. 25. This makes it possible to reduce an area of a dark portion in the light guide 22.

However, since prisms that extend in a direction substantially vertical to the light incident end surface are formed on a light exit surface of the light guide 22 or a surface facing the light exit surface as illustrated in (b) of FIG. 25, the light spread in a horizontal direction in the light guide is reflected by these prisms so as to be converted into light spread in the thickness direction of the light guide. For example, light spread to the point C in the horizontal direction in (c) of FIG. 25 is converted into light spread to the point D in the thickness direction.

Further, in a case where the prisms 1 formed on the light incident end surface have an angle as shown in (d) of FIG. 25, the light that has been converted into light spread in the thickness direction of the light guide contain light whose incident angle to the light exit surface of the light guide 22 or the surface of the light guide 22 which surface faces the light exit surface becomes smaller than a critical angle, as illustrated in (e) of FIG. 25. This light causes a light loss.

As shown in (f) of FIG. 25, the maximum spread of the light having entered the light guide 22 is calculated as follows:

From the Snell's law (n·sin(x)=sin(90−ψ)=cos ψ), the following is obtained

x=arcsin(cos ψ/n).

Accordingly, the maximum spread angle of the light having entered the light guide 22 is expressed as follows:

x+ψ=arcsin(cos ψ/n)+ψ

The present invention was attained in view of the above problems, and an object of the present invention is to provide a planar lighting device that is excellent in luminance uniformity and light use efficiency, and a display device including the planar lighting device.

Specifically, according to the planar lighting device of the present invention, light whose angle has been expanded by prisms (optical pattern) formed on a light incident surface (light incident end surface) is guided through a light guide plate in a manner such that the light is reflected, in a direction substantially vertical to the light incident surface, by a prism (optical pattern) formed, in a vicinity of a light source, on a light exit surface of a light guide. This achieves a smaller light loss in an ineffective region in the vicinity of the light incident surface and a smaller light loss from a side surface of the light guide plate, as compared with the planar light source device disclosed in Patent Literature 1.

Further, the light guide provided in the planar lighting device of the present invention can have a plurality of prisms (optical patterns) formed, in the vicinity of the light source, on the light exit surface. This allows more light to be changed in the direction substantially vertical to the light incident surface, as compared with the light guide plate disclosed in Patent Literature 2. Furthermore, the pattern (optical pattern) in the vicinity of the light incident surface can be formed concurrently with formation of the prisms formed, in the vicinity of the light source, on the light exit surface. Accordingly, the formation of the pattern is easy.

### Solution to Problem

A planar lighting device of the present invention includes: a light source; a light guide having (i) a light incident surface which allows light emitted from the light source to enter the light guide, (ii) a light exit surface from which the light having entered the light guide exits, and (iii) a back surface facing the light exit surface; and a reflecting member which is disposed so as to face the back surface, the reflecting member reflecting the light emitted from the back surface so that the light enters the light guide again, the light guide including: a first optical member formed on the light incident surface, the first optical member diffusing the light emitted from the light source towards an inside of the light guide; a second optical member formed on the light exit surface or the back surface, the second optical member changing an angle of the light inside the light guide; a third optical member formed on the light exit surface or the back surface, the third optical member diffusing the light inside the light guide; and a fourth optical member formed on the light exit surface or the back surface so as to be close to the light incident surface, the fourth optical member focusing, inside the light guide, the light diffused by the first optical member, the fourth optical member having a concave part set back into the light exit surface or the back surface.

According to the arrangement, the first optical member causes the light emitted from the light source to be diffused inside the light guide mainly in a width direction of the light guide, and the light is reflected by a side surface of a concave part of the fourth optical member so that the light is focused, inside the light guide, mainly in a longitudinal direction of the light guide. Further, the light is guided through the light guide while the angle of the light is repeatedly changed by the second optical member and the light is repeatedly diffused by the third optical member. According to the planar lighting device of the present invention, it is therefore possible to reduce an ineffective region and to reduce a light loss in the vicinity of the light source. As a result, the planar lighting device of the present invention allows an improvement in luminance uniformity and light use efficiency.

### ADVANTAGEOUS EFFECTS OF INVENTION

As described above, the planar lighting device of the present invention includes: a light source; a light guide having (i) a light incident surface which allows light emitted from the light source to enter the light guide, (ii) a light exit surface from which the light having entered the light guide exits, and (iii) a back surface facing the light exit surface; and a reflecting member which is disposed so as to face the back surface, the reflecting member reflecting the light emitted from the back surface so that the light enters the light guide again, the light guide includes: a first optical member formed on the light incident surface, the first optical member diffusing the light emitted from the light source towards an inside of the light guide; a second optical member formed on the light exit surface or the back surface, the second optical member changing an angle of the light inside the light guide; a third optical member formed on the light exit surface or the back surface, the third optical member diffusing the light inside the light guide; and a fourth optical member formed on the light exit surface or the back surface so as to be close to the light incident surface, the fourth optical member focusing, inside the light guide, the light diffused by the first optical member, the fourth optical member having a concave part set back into the light exit surface or the back surface.

This produces an effect that the planar lighting device of the present invention is excellent in luminance uniformity and light use efficiency.

### BRIEF DESCRIPTION OF DRAWINGS

FIG. 1 is a side view illustrating an outline configuration of a liquid crystal display device including a backlight device of an embodiment of the present invention.

FIG. 2 is a perspective view illustrating an outline configuration of a backlight device of the embodiment of the present invention.

FIG. 3 is a side view illustrating an outline configuration of a backlight device of the embodiment of the present invention.

FIG. 4 is a diagram illustrating a backlight device of the embodiment of the present invention, (a) of FIG. 4 illustrates an outline configuration of the backlight device, (b) of FIG. 4 illustrates a cross-section of an outline configuration of a light guide provided in the backlight device, and (c) of FIG. 4 illustrates a cross-section of a part of the light guide provided in the backlight device.

FIG. 5 is a plan view illustrating an outline configuration of a backlight device of the embodiment of the present invention.

FIG. 6 is a plan view illustrating an outline configuration of a backlight device of the embodiment of the present invention.

FIG. 7 is a plan view illustrating a backlight device of the embodiment of the present invention, (a) of FIG. 7 illustrates an outline configuration of the backlight device, and (b) of FIG. 7 illustrates a part of a light guide provided in the backlight device.

FIG. 8 is a plan view illustrating an outline configuration of a backlight device of the embodiment of the present invention.

FIG. 9 is a diagram illustrating an angular distribution of light when viewed from a direction (z-direction) vertical to the light incident surface of a light guide provided in a backlight device of the embodiment of the present invention.

FIG. 10 is a plan view illustrating an outline configuration of a backlight device of the embodiment of the present invention.

FIG. 11 is a diagram illustrating a backlight device of the embodiment of the present invention, (a) of FIG. 11 illustrates an outline configuration of the backlight device, and (b) of FIG. 11 is a plan view illustrating an outline configuration of a light guide provided in the backlight device.

FIG. 12 is a diagram illustrating a backlight device of another embodiment of the present invention, (a) of FIG. 11 illustrates an outline configuration of the backlight device, (b) and (c) of FIG. 12 is a side view illustrating the outline configuration of the backlight device, and (d) of FIG. 12 is a plan view illustrating the outline configuration of the backlight device.

FIG. 13 is a diagram illustrating an angular distribution of light when viewed from a direction (z-direction) vertical to a light incident surface of a light guide provided in a backlight device of the embodiment of the present invention.

FIG. 14 is a side view illustrating an outline configuration of a backlight device of the embodiment of the present invention.

FIG. 15 is a diagram illustrating a backlight device of still another embodiment of the present invention, (a) of FIG. 15 illustrates an outline configuration of the backlight device, (b) and (c) of FIG. 15 is a side view illustrating the outline configuration of the backlight device, and (d) of FIG. 15 is a plan view illustrating the outline configuration of the backlight device.

FIG. 16 is a side view illustrating an outline configuration of a backlight device of the embodiment of the present invention.

FIG. 17 is a side view illustrating a production process of a light guide provided in a backlight device of an embodiment of the present invention.

FIG. 18 is a side view illustrating a production process of the light guide provided in the backlight device of the embodiment of the present invention.

FIG. 19 is a side view illustrating a production process of the light guide provided in the backlight device of the embodiment of the present invention.

FIG. 20 is a side view illustrating a production process of a light guide provided in a backlight device of another embodiment of the present invention.

FIG. 21 is a side view illustrating a production process of the light guide provided in the backlight device of the embodiment of the present invention.

FIG. 22 is a side view illustrating a production process of the light guide provided in the backlight device of the embodiment of the present invention.

FIG. 23 is a plan view illustrating an outline configuration of a conventional backlight device.

FIG. 24 is a diagram illustrating a conventional backlight device, (a) of FIG. 24 illustrates an outline configuration of the backlight device, and (b) of FIG. 24 is a plan view illustrating the outline configuration of the backlight device.

FIG. 25 is a diagram for explaining how a light loss occurs in a backlight device of an embodiment of the present invention.

### DESCRIPTION OF EMBODIMENTS

### Embodiment 1

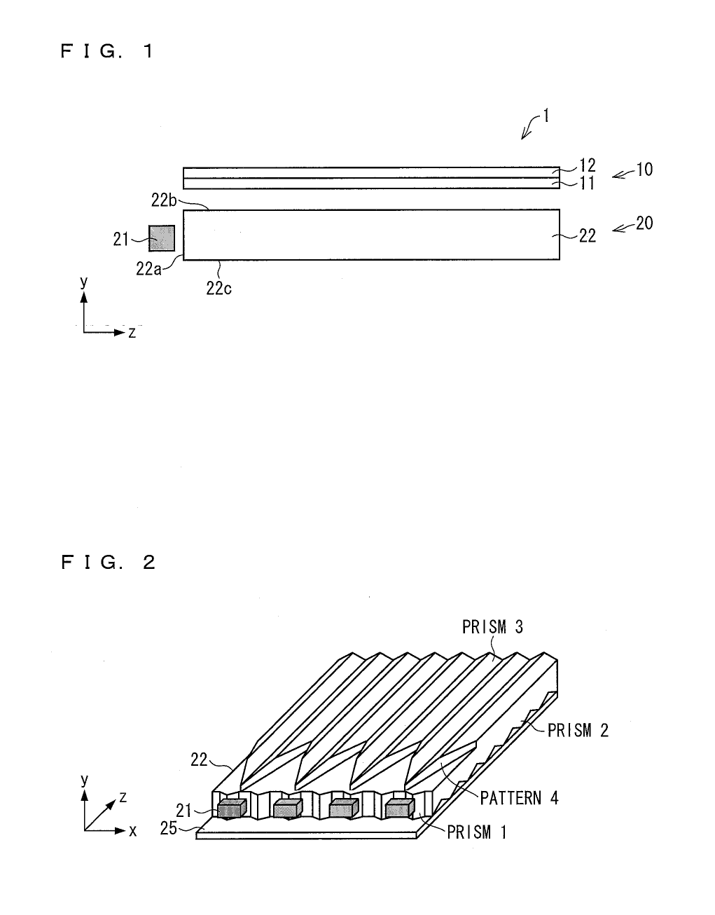

An embodiment of the present invention is described below with reference to FIGS. 1 through 11 and FIGS. 17 through 19. Note that the present invention is not limited to this. Dimensions, materials, shapes, and relative positions of constituent components described in this embodiment are merely examples, and do not intend to limit the scope of the present invention, unless otherwise specified.

<Display Device>

As illustrated in FIG. 1, a liquid crystal display device (display device) 1 of the present invention includes a liquid crystal display panel (display panel) 10, a backlight device (planar lighting device) 20 provided on a back surface side (side opposite to a display surface) of the liquid crystal display panel 10, and a frame (not shown) in which the liquid crystal display panel 10 and the backlight device 20 are provided. Note that the liquid crystal display device 1 is one example of “display device” of the present invention, the liquid crystal display panel 10 is one example of “display panel” of the present invention, and the backlight device 20 is one example of “planar lighting device” of the present invention.

The liquid crystal display panel 10 includes an AM substrate (active matrix substrate) 11, a counter substrate 12 provided so as to face a front surface (display surface) of the AM substrate 11, and a liquid crystal layer (not shown) disposed between the AM substrate 11 and the counter substrate 12.

As illustrated in FIGS. 1 and 2, the backlight device 20 is an edge-light backlight device, and includes a plurality of light sources 21 aligned in an X-direction (see FIG. 2), and a light guide 22 which guides light from the light sources 21.

The AM substrate 11 included in the liquid crystal display panel 10 can be, for example, a TFT substrate provided with a plurality of active elements such as TFTs (Thin Film Transistors). The counter substrate 12 included in the liquid crystal display panel 10 can be, for example, a CF (color filter) substrate or the like.

The TFT substrate is, for example, configured such that a pixel electrode made of ITO (Indium Tin Oxide) and an active element such as a TFT (Thin Film Transistor) are provided per pixel on a glass substrate, and on these members, a vertical alignment film (alignment film) and a polymer layer (polymerized film) are provided in this order from the glass substrate side so as to cover these members.

Meanwhile, the CF substrate is, for example, configured such that a color filter layer in which R, G, and B color filters are provided per pixel is provided on a glass substrate, BM (black matrix) is formed between the color filters, and a common electrode made of ITO (Indium Tin Oxide), a vertical alignment film (alignment film), and a polymer layer (polymerized film) are provided in this order from the glass substrate side so as to cover the color filters and the BM.

The light sources 21 are point light sources, and any of (i) white LED (light-emitting diode) light sources, (ii) RGB-LED (light-emitting diode in which R, G, and B chips are molded in a single package) light sources, (iii) multicolor LED light sources, and (iv) laser light sources can be suitably used as the light sources 21.

The light guide 22 has a light incident surface 22a, a light exit surface 22b, and a surface (hereinafter also referred to as “back surface”) 22c facing the light exit surface 22b of the light guide 22. The light incident surface 22a receives light emitted from the light sources 21, and the light thus received is surface-emitted from the light exit surface 22b.

Further, a reflecting plate 25 may be provided so as to face the back surface (surface facing the light exit surface 22b) 22c of the light guide 22. The reflecting plate 25 is provided so as to be in contact with the back surface 22c of the light guide 22. The reflecting plate 25 reflects light so that more light can be outputted from the light exit surface 22b.

The light incident surface 22a of the light guide 22 is substantially parallel to light exit surfaces of the light sources 21. The light guide 22 is made of acrylic, polycarbonate, or the like. Details of the light guide 22 are described later.

The liquid crystal display device 1 of the present invention may include an optical member, such as a diffusion plate or a light focusing lens, between the light guide 22 of the backlight device 20 and the liquid crystal display panel 10.

The diffusion plate is disposed so as to cover the entire light exit surface 22a of the light guide 22 and face the light exit surface 22a at a predetermined distance from the light exit surface 22a. The diffusion plate diffuses light outputted from the light exit surface 22a of the light guide 22 so that the liquid crystal display panel 10 is irradiated by the light. Examples of the diffusion plate include a prism sheet, diffusing sheet, and the like. The light focusing lens evens out and focus the light outputted from the light exit surface 22a of the light guide 22 so that the liquid crystal display panel 10 is irradiated by the light. It is preferable that the diffusion plate and the light focusing lens be used in an appropriate combination depending on price, performance, etc. of the liquid crystal display device 1.

<Specific Configuration of Light Guide and Backlight Device (Planar Lighting Device)>

The details of the light guide 22 and the backlight device 20 of the present invention are described below with reference to FIGS. 2 through 11.

As illustrated in FIG. 2, the light guide 22 has optical patterns, specifically, a prism 1 (first optical member), a prism 2 (second optical member), a prism 3 (third optical member), and a pattern 4 (fourth optical member).

As illustrated in FIG. 2, the light guide 22 has a substantially rectangular parallelepiped shape or a substantially cubic shape, and the prism 2 which gradually changes an angle of light guided through the light guide 22 is formed on at least the light exit surface 22b or the back surface (surface facing the light exit surface 22b) 22c (the prism 2 is formed on the back surface 22c in FIG. 2).

The prism 2 is not limited to a specific shape, provided that it can change an angle of light guided through the light guide 22. The prism 2 can be, for example, a saw-shaped prism row, lenticular lens row, v-shaped groove lens row, or a rough surface such as a dot-shape. The prism 2 extends in a lateral direction (the x-direction in FIG. 2). This allows the angle of the light to be changed only in y-z directions without causing the light to be diffused in the lateral direction (the x-direction in FIG. 2), thereby achieving easy control of the angle of the exit light.

Further, the prism 3 which diffuses, in the lateral direction (the x-direction in FIG. 2), the light guided through the light guide 22 is formed on at least the light exit surface 22b or the back surface (surface facing the light exit surface 22b) 22c of the light guide 22 (the prism 3 is formed on the light exit surface 22b in FIG. 2).

The prism 3 is not limited to a specific shape, provided that it can diffuse, in the lateral direction, the light guided through the light guide 22. The shape of the prism 3 can be, for example, a convex shape, a concave shape, a semicylindrical shape, or a shape of a v-shaped groove. The prism 3 extends in a longitudinal direction (the z-direction in FIG. 2).

Another arrangement is also possible in which the prism 2 and the prism 3 are formed so as to overlap each other on an identical surface.

Further, the prism 1 which diffuses, in the lateral direction (the x-direction in FIG. 2), the light having entered the light guide 22 from the light source 21 is formed on the light incident surface 22a of the light guide 22.

The prism 1 is not limited to a specific shape, provided that it can diffuse, in the lateral direction, the light having entered the light guide 22 from the light source 21. The shape of the prism 1 can be, for example, a convex shape, a concave shape, a semicylindrical shape, or a shape of a v-shaped groove. The prism 1 extends in a thickness direction (the y-direction in FIG. 2).

Note that if the prism 1 diffuses the light in the thickness direction (the y-direction in FIG. 2), the light having entered the light guide 22 exits directly from the light exit surface 22b or the back surface 22c. This causes a light loss in an ineffective region.

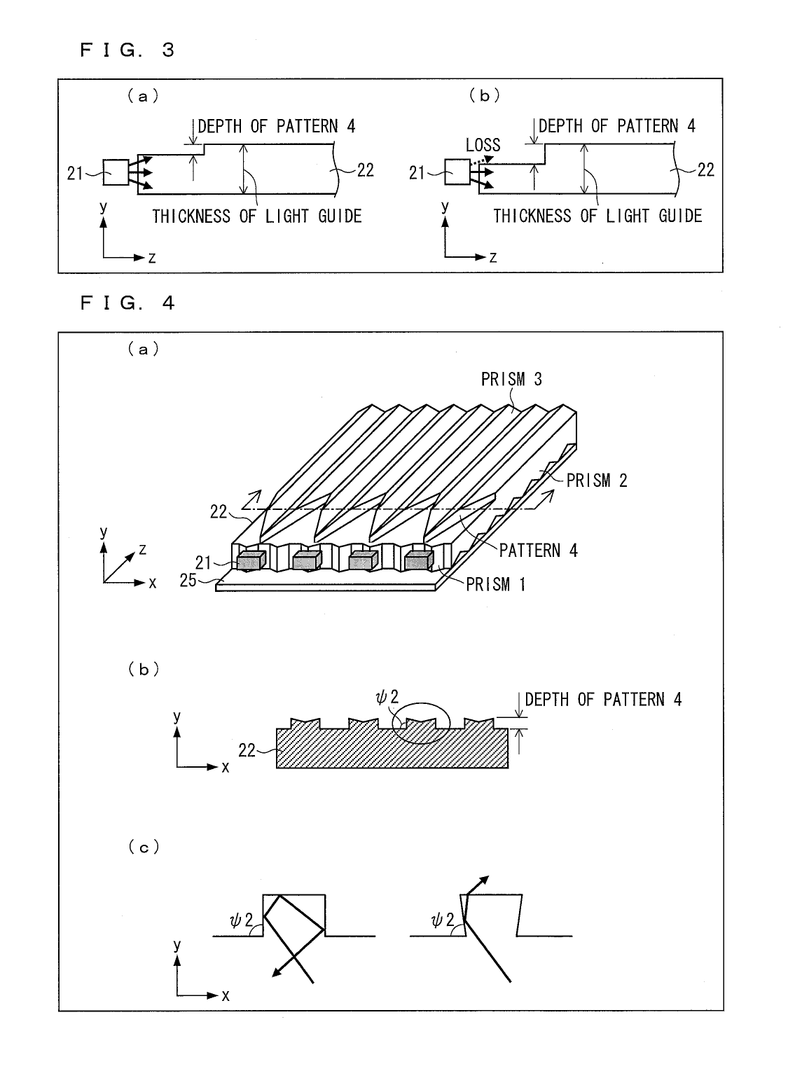

As illustrated in (a) and (b) of FIG. 3 and (a) through (c) of FIG. 4, the pattern 4 which focuses, in the longitudinal direction (the z-direction in FIG. 2), the light guided through the light guide 22 is formed on at least one surface of the light guide 22 (the pattern 4 is formed on the light exit surface 22b in (a) of FIG. 4).

The pattern 4 has a concave shape when the light guide 22 is viewed from the light sources 21. The shape of the pattern 4 is described below with reference to (a) and (b) of FIG. 3 and (a) through (c) of FIG. 4.

(a) and (b) of FIG. 3 each illustrate an outline configuration of a backlight device of the embodiment of the present invention. As illustrated in (a) of FIG. 3, the maximum depth of a concave part of the pattern 4 is smaller than (thickness of the light guide 22 (width in the y-direction in FIG. 3))−(thickness of a light exit section of the light source 21 (width in the y-direction in FIG. 3)).

As illustrated in (b) of FIG. 3, in a case where the maximum depth of the concave part of the pattern 4 is larger than this value, light which does not enter the light guide 22 out of the light emitted from the light sources 21 increases, i.e., a light loss increases.

Meanwhile, it is preferable that the maximum depth of the concave part of the pattern 4 is as large as possible, provided that it does not exceed the above upper limit. The maximum depth of the concave part of the pattern 4 is larger than at least a depth of the prism (the prism 3 in FIG. 3) formed on an identical surface to the pattern 4. This is because in a case where the maximum depth of the concave part of the pattern 4 is smaller than the depth of the prism (the prism 3 in FIG. 3) formed on the identical surface to the pattern 4, a reflecting surface of the pattern 4 cannot be made sufficiently large.

The maximum depth of the concave part of the pattern 4 is calculated on the basis of the highest position of the prism (the prism 3 in FIG. 3) formed on the identical surface to the pattern 4.

(a) of FIG. 4 illustrates an outline configuration of a backlight device the embodiment of the present invention, (b) of FIG. 4 illustrates an outline configuration of a light guide provided in a backlight device of the embodiment of the present invention, and (c) of FIG. 4 illustrates a part of a light guide provided in a backlight device of the embodiment of the present invention. As illustrated in (b) and (c) of FIG. 4, it is preferable that an angle ψ2 of the concave part of the pattern 4 is approximately 90°. In a case where the angle ψ2 is deviated from approximately 90°, light reflected by the pattern 4 exits from the light exit surface 22b or the back surface 22c. This causes a light loss in an ineffective region.

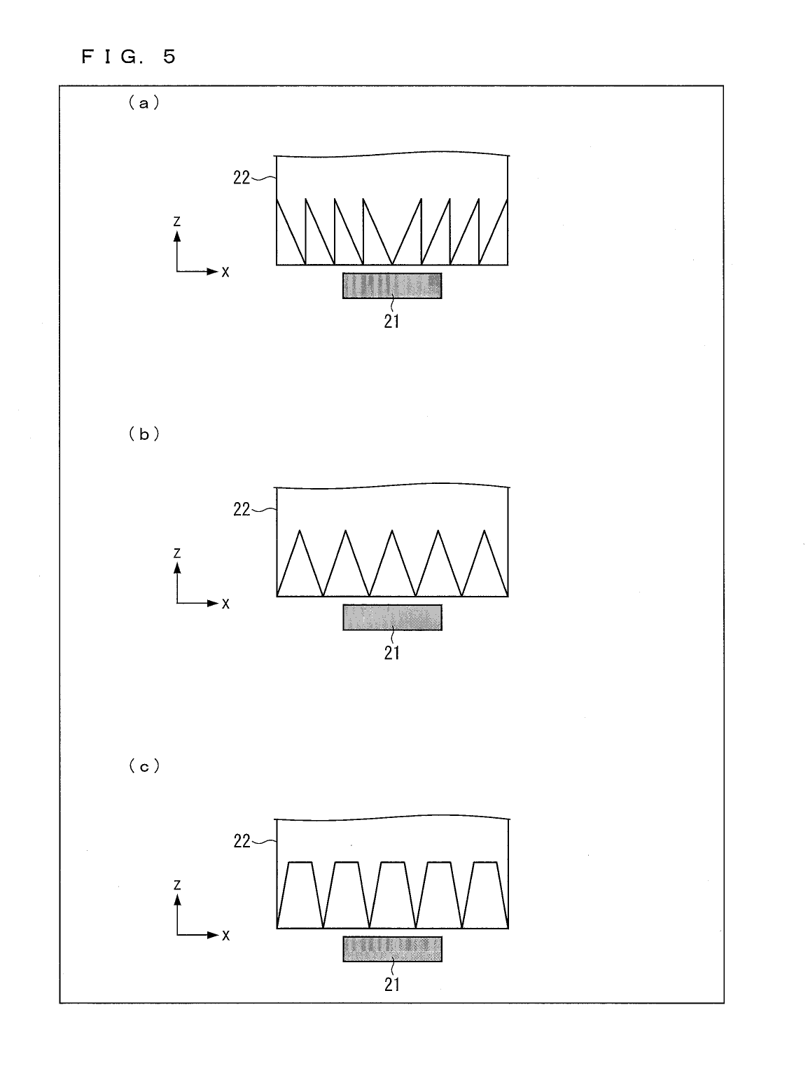

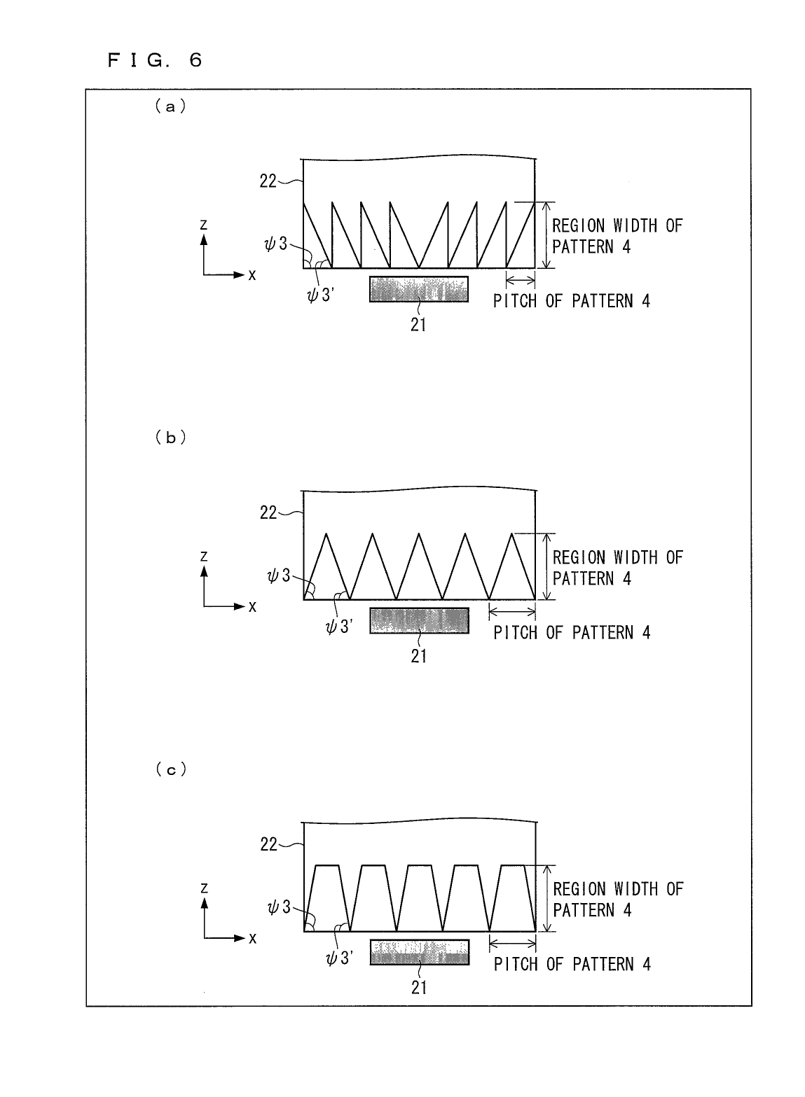

(a) through (c) of FIG. 5 and (a) through (c) of FIG. 6 each illustrate an outline configuration of a backlight device of the embodiment of the present invention. Specifically, (a) through (c) of FIG. 5 and (a) through (c) of FIG. 6 each illustrate a shape of the pattern 4 when viewed from the light exit surface 22b side.

Since the light focusing effect improves as an area of a side surface of the concave part of the pattern 4 becomes larger, it is preferable that the concave parts of the pattern 4 are disposed with no space therebetween in the vicinity of the light sources 21. Further, since the light focusing effect improves as an area of the reflecting surface of the pattern 4 in the vicinity of the light sources 21 becomes larger, a pitch (width in the x-direction in FIG. 6) of the pattern 4 is at least smaller than the width of the light source 21 (width in the x-direction in FIG. 6).

Further, a region width (width in the z-direction in FIG. 6) of the pattern 4 is, for example, within a range of an ineffective region of the display device.

As illustrated in (a) of FIG. 6, an angle ψ3 and an angle ψ3′ of the pattern 4 viewed from the light exit surface 22b side may be different from each other. In a case where the angle ψ3 and the angle ψ3′ of the pattern 4 are different from each other, it is preferable that one of the angle ψ3 and the angle ψ3′ which one is closer to a center of a light source 21 disposed closest to the pattern 4 is smaller than the other one. Meanwhile, in a case where the angle ψ3 and the angle ψ3′ of the pattern 4 are substantially equal to each other, there is no need to consider the position of the light source 21.

Further, as illustrated in (c) of FIG. 6, an angle of the pattern 4 viewed from the light exit surface 22b side need not be an acute angle.

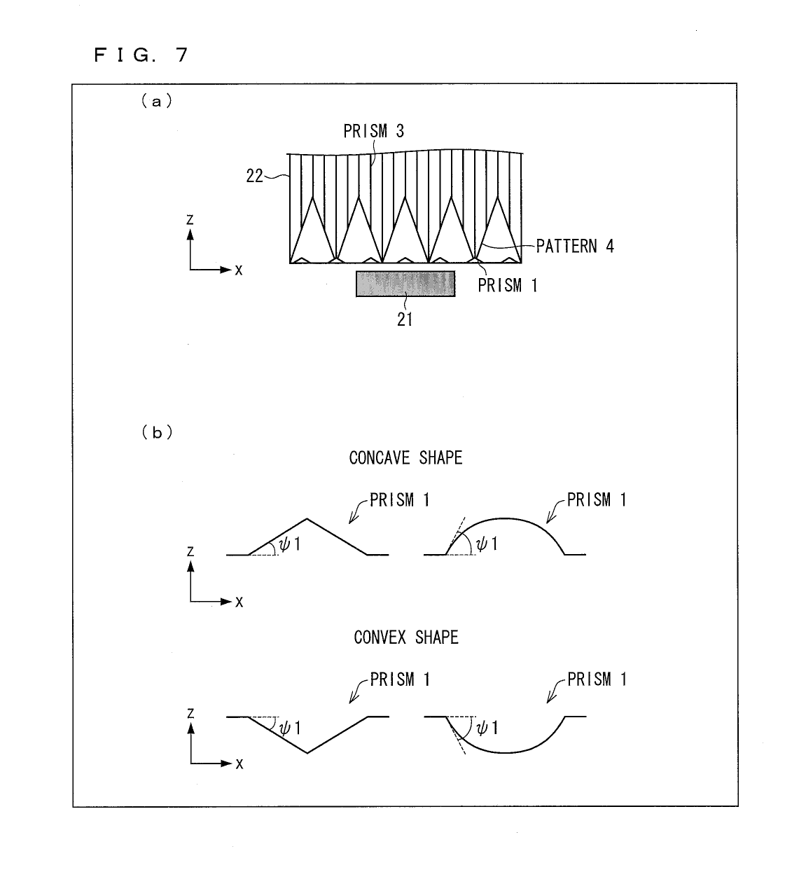

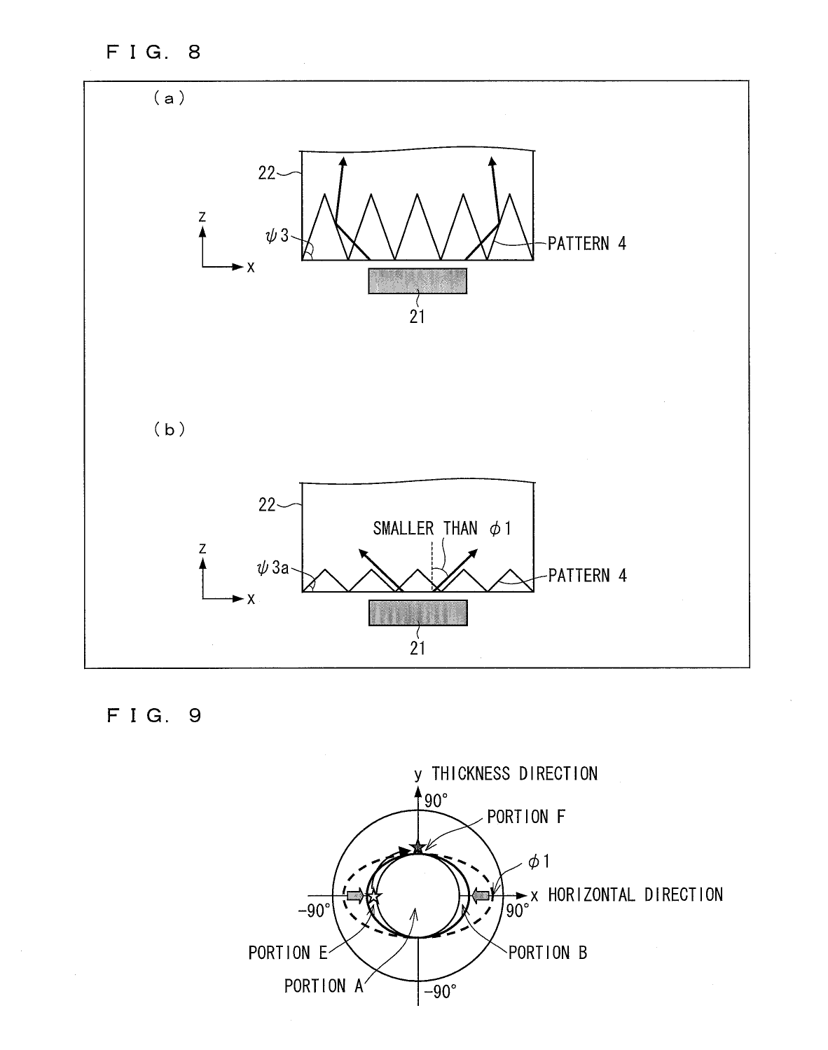

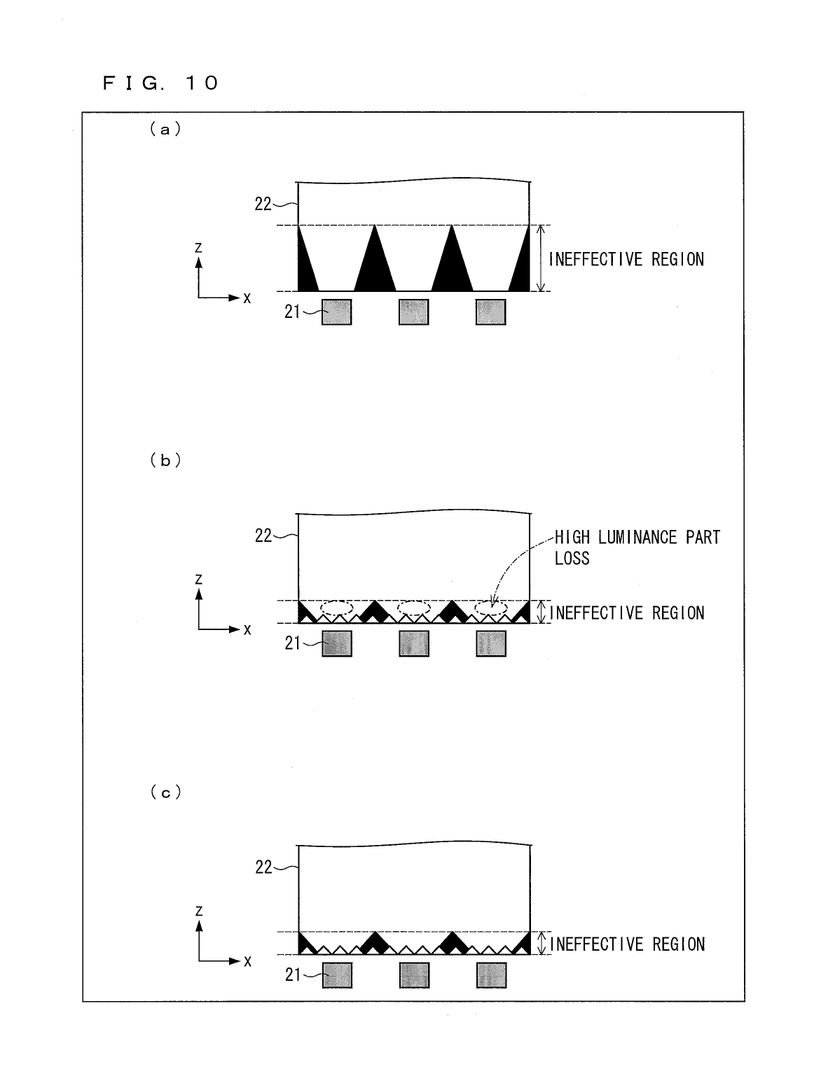

(a) of FIG. 7 illustrates an outline configuration of a backlight device of the embodiment of the present invention, and (b) of FIG. 7 illustrates a part of a light guide provided in a backlight device the embodiment of the present invention. (a) and (b) of FIG. 8 illustrates an outline configuration of a backlight device of the embodiment of the present invention. FIG. 9 illustrates an angular distribution of light when viewed from a direction (the z-direction) vertical to a light incident surface of a light guide provided in a backlight device of the embodiment of the present invention.

The maximum spread angle of light having entered the light guide 22 from an air layer (region between the light guide 22 and the liquid crystal display panel 10) in the light guide 22 is expressed as follows:

θ1=arcsin(1/n)

where n is a refractive index of the light guide 22 and ψ1 is the maximum angle of the prism 1 with respect to the light incident surface 22a.

Further, φ1 is the maximum spread angle of light in the light guide. For example, in a case where the prism 1 is recessed into the light incident surface 22a, the spread of the light is expressed as follows:

φ1=arcsin(cos ψ/n)+ψ

It is known that a critical angle is generally expressed by the following equation in accordance with the Snell's law:

θ=arcsin(n2/n1)

Since n1 is the refractive index n of the light guide and n2 is a refractive index of air, i.e., 1, the following is satisfied:

θ1=arcsin(1/n)

Further, from the Snell's law (n·sin(x)=sin(90−ψ)=cos ψ), the following is obtained:

x=arcsin(cos ψ/n)

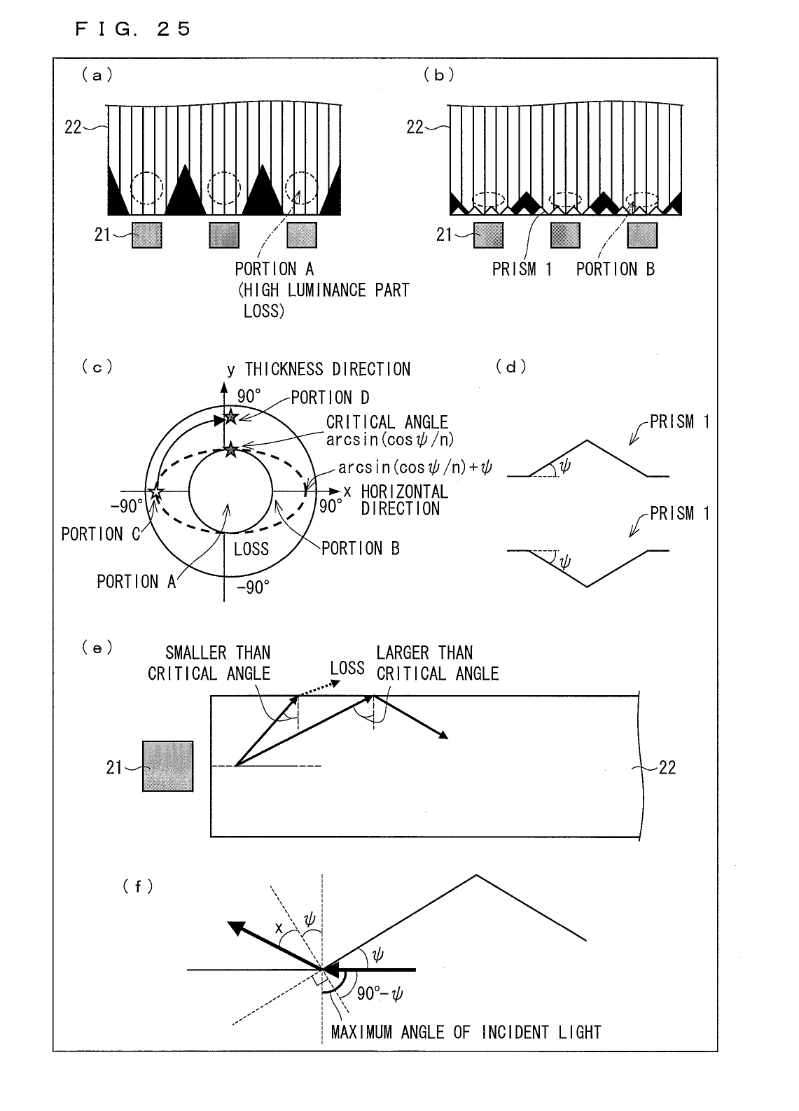

Accordingly, the maximum spread angle is expressed as follows (see (f) of FIG. 25):

φ1=arcsin(cos ψ/n)+ψ

The light emitted from the light sources 21 has the highest intensity in the z-direction, and has a spread angle of ±90° in the x-direction and the y-direction.

When the light emitted from the light sources 21 enters the light guide 22 having the refractive index n1, the light is refracted so that a spread angle of the light in the y-direction in the light guide 22 becomes ±θ1. However, since the light spreads in the x-direction by the prism 1, the spread angle of the light in the x-direction is ±φ1.

In a case where an angle (ψ3a in (b) of FIG. 8) of the pattern 4 is smaller than the spread angle of ±φ1, the light is not reflected by the side surface of the pattern 4. Accordingly, the effect of focusing the light in the z-direction cannot be obtained. In view of this, ψ3 is expressed as follows:

90°−φ1≦ψ3≦90°

In a case where the pattern 4 is formed so as to satisfy the above range, the light in the x-direction is focused in the z-direction by the pattern 4. Accordingly, the angular distribution of the light in the x-direction becomes small (change shown by the portion B in FIG. 9). Consequently, even after the angle is changed by the prism 1, the angle of the light with respect to the surface of the light guide 22 becomes equal to or larger than the critical angle. This allows a reduction in light loss in the vicinity of the light sources 21.

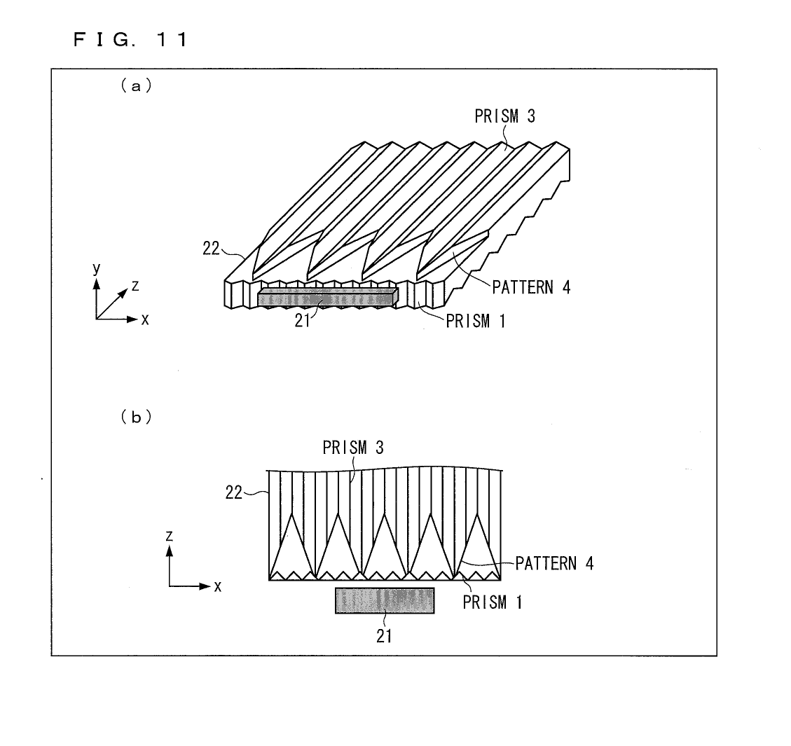

(a) through (c) of FIG. 10 each illustrate an outline configuration of a backlight device of the embodiment of the present invention. Specifically, (a) of FIG. 10 illustrates a backlight device provided with only the prisms 2 and 3, (b) of FIG. 10 illustrates a backlight device provided with only the prisms 1, 2, and 3, and (c) of FIG. 10 illustrates a backlight device (backlight device of the present invention) provided with the prisms 1, 2, and 3, and the pattern 4.

The backlight device illustrated in (c) of FIG. 10 achieves a smaller ineffective region width and a smaller light loss in the ineffective region, as compared with the backlight device illustrated in (a) of FIG. 10. Further, the backlight device illustrated in (c) of FIG. 10 achieves a smaller light loss in the ineffective region, as compared with the backlight device illustrated in (b) of FIG. 10.

As described above, the backlight device 20 of the present invention which includes the light guide 22 has the pattern 4 formed, in the vicinity of the light sources 21, on the light exit surface 22b of the light guide 22 or the surface 22c of the light guide 22 which surface faces the light exit surface 22b, as illustrated in (a) and (b) of FIG. 11.

This allows the light spread in the horizontal direction by the prism 1 formed on the light incident surface to be focused by the pattern 4 (concave shape) formed in the vicinity of the light sources 21 before an angle of the light thus spread is changed by the prism 2 and a light loss occurs. As a result, it is possible to reduce an area of a dark portion between the light sources to which no light reaches and to reduce spread of the angular distribution of the light in the horizontal direction inside the light guide, thereby suppressing a light loss.

<Method for Producing Light Guide>

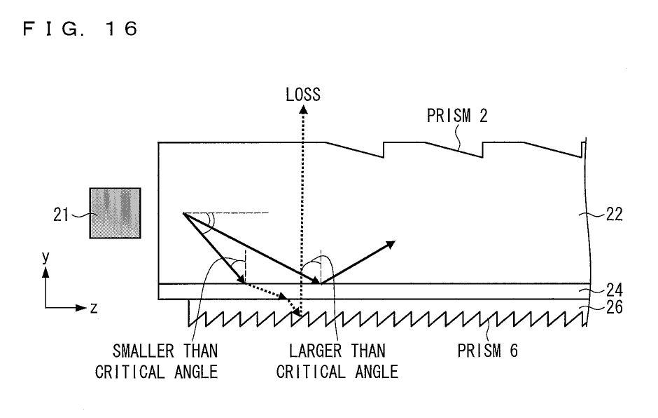

With reference to FIGS. 17 through 19, the following describes a method of the present embodiment for producing the light guide 22.

First, the light guide 22 is formed by using a thermal imprint process. Specifically, a film material 22k made of a transparent resin or the like is disposed between an upper mold 30 and a lower mold 31 as illustrated in FIG. 17. Then, the film material 22k is heated and pressed by the upper mold 30 and the lower mold 31 as illustrated in FIG. 18. Thus, the film material 22k is formed into a desired shape. Note that the desired shape means any of the above-mentioned shapes in the light guide 22.

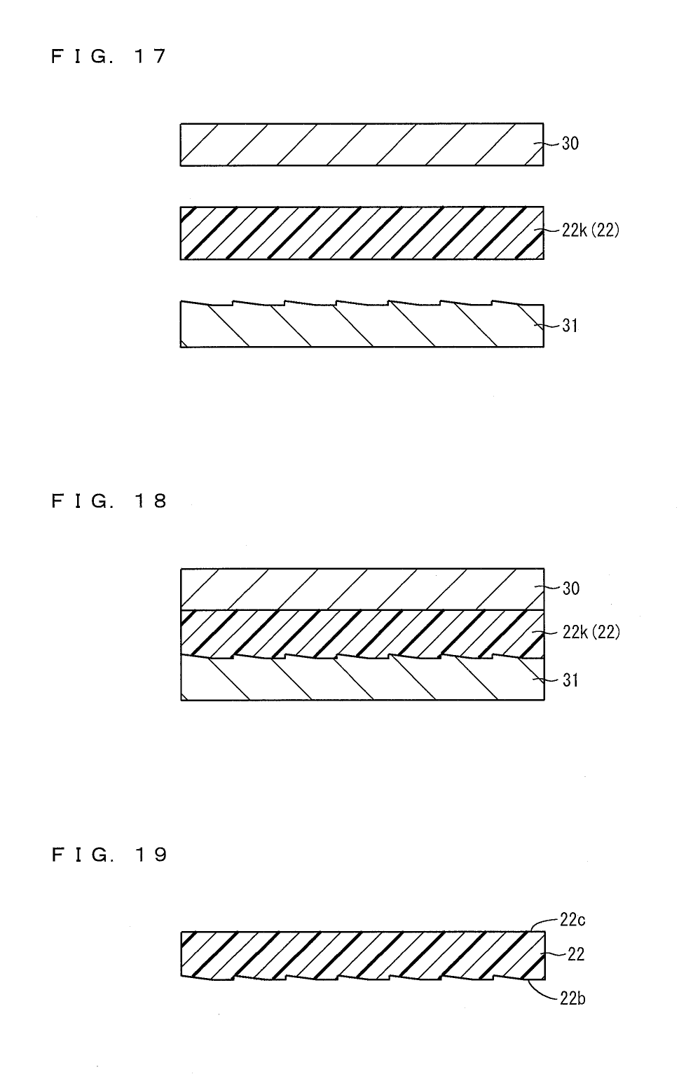

Then, the film material 22k is detached from the upper mold 30 and the lower mold 31, and is then cooled and divided into individual pieces. Thus, the light guide 22 is obtained as illustrated in FIG. 19.

Although the light guide 22 can be formed by using injection molding instead of the imprint process, the light guide 22 can be produced by a roll-to-roll process in a case where the light guide 22 is formed with the use of the film material 22k by using the imprint process. This makes it possible to shorten a time required for the production and to reduce a production cost.

The prism 1 may be formed by cutting the film material with the use of a blade etc. that has been machined into a certain shape so that the prism 1 is formed concurrently with the cutting or may be formed by an imprint process, embossing, or the like after the cutting.

It is desirable that the pattern 4 is incorporated into the mold for the imprint. This makes it possible to form the pattern 4 by a single imprint process.

<Pattern 4 (Fourth Optical Member)>

The pattern 4 (fourth optical member) formed in the present invention may be, for example, an asymmetrical pattern shown in (a) of FIG. 5 instead of the symmetrical patterns shown in (b) and (c) of FIG. 5. Further, since the pattern 4 formed in the present invention is incorporated into the upper mold 30 or the lower mold 31 used in the method for producing the light guide, patterns 4 are formed concurrently by the imprint process in the production of the light guide.

<Prisms 1, 2, and 3 (First, Second, and Third Optical Members)]

The prisms 1 through 3 (first through third optical members) formed in the present invention may be formed by attaching prism sheets.

### Embodiment 2

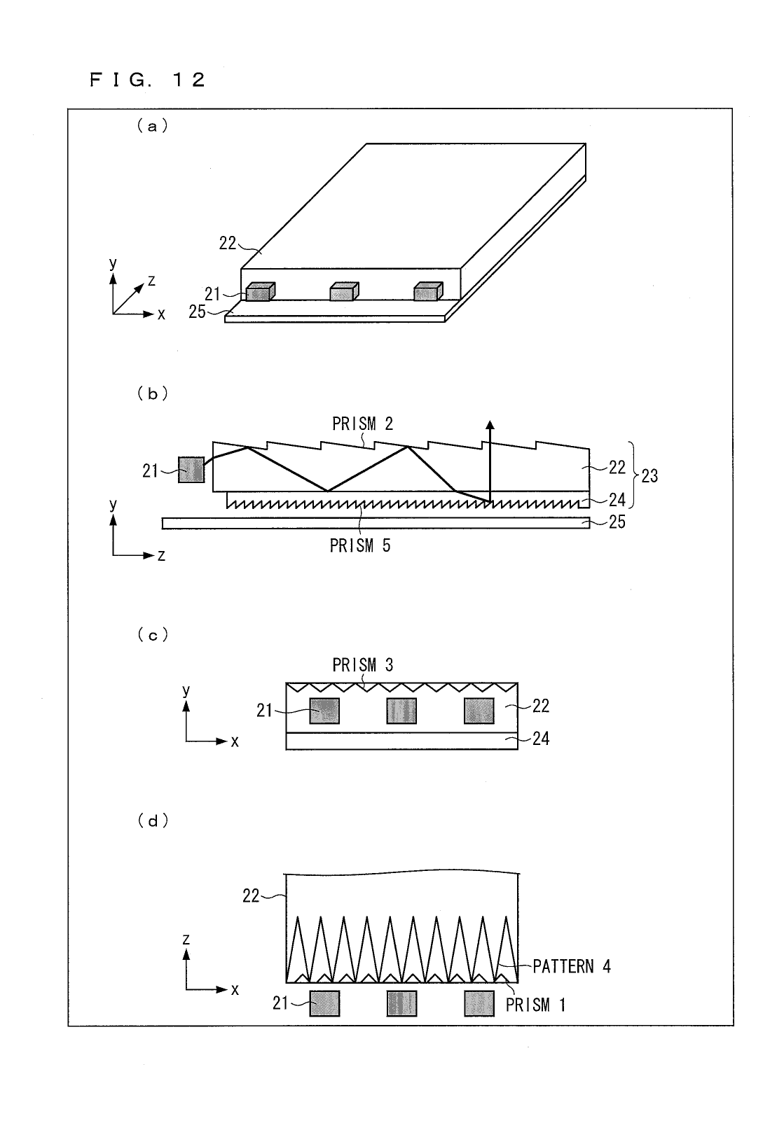

Another embodiment of the present invention concerning optical members is described below with reference to FIGS. 12 through 14 and FIGS. 20 through 22. For convenience of description, members that have identical functions to those in the drawings described in Embodiment 1 are given identical reference numerals, and are not explained repeatedly.

<Specific Configuration of Light Guide and Backlight Device (Planar Lighting Device)>

(a) of FIG. 12 is a perspective view illustrating an outline configuration of a backlight device of the present embodiment, (b) and (c) of FIG. 12 are side views each illustrating an outline configuration of the backlight device of the present embodiment, and (d) of FIG. 12 is a plan view illustrating an outline configuration of the backlight device of the present embodiment.

As illustrated in (b) of FIG. 12, the backlight device of the present embodiment includes a low refractive index layer 24 between a light guide 22 and a reflecting plate 25. In the present specification, the light guide 22 and the low refractive index layer 24 are collectively referred to as a light guide member 23.

The light guide member 23 is constituted by (i) the light guide 22 which is made of a transparent material having a refractive index n1 and which has a substantially rectangular parallelepiped shape or a substantially cubic shape and (ii) a low refractive index layer 24 which is made of a transparent material having a refractive index n2 and which is attached to a bottom surface of the light guide 22 with no air interposed therebetween. Note that a material having a refractive index n′ different from the refractive indices n1 and n2 may be provided between the light guide 22 and the low refractive index layer 24, but the refractive index n′ needs to satisfy n2<n′≦n1.

The refractive index n1 of the light guide 22 and the refractive index n2 of the low refractive index layer satisfy n2<n1, and preferably satisfy n1/n2>1.8.

The light guide 22 has a substantially rectangular parallelepiped shape or a substantially cubic shape, and a prism 2 which gradually changes an angle of light guided through the light guide 22 is formed on at least a surface (a light exit surface 22b or a surface that is in contact with the low refractive index layer 24 (the prism 2 is formed on the light exit surface in FIG. 12)) of the light guide 22.

The prism 2 is not limited in particular, provided that it can gradually change an angle of light. The prism 2 can be for example, a saw-shaped prism row, a v-shaped groove lens row, or the like. The prism 2 extends in the lateral direction (the x-direction in FIG. 2).

Further, a prism 3 which diffuses light in the lateral direction (the x-direction) is formed on at least one surface (the light exit surface 22b or the surface that is in contact with the low refractive index layer 24) of the light guide 22. Note that the prism 3 may be formed on an identical surface to the prism 2 so that the prism 3 and the prism 2 overlap each other (the prism 3 is formed on the light exit surface side so as to overlap the prism 2 in FIG. 12).

Further, a prism 1 which diffuses light in the x-direction is formed on a light incident surface facing light sources 21.

Further, the pattern 4 which focuses light in a substantially traveling direction (the z-direction) is formed on at least one surface of the light guide 22 (the pattern 4 is formed on the light exit surface in FIG. 12). In a case where the pattern 4 is formed on the surface facing the light exit surface, the pattern 4 is formed on the surface of the light guide 22 which surface faces the low refractive index layer 24. Even if the pattern 4 is formed on the low refractive index layer 24, an amount of light entering the low refractive index layer 24 out of light having entered the light guide 22 from the light sources 21 is restricted due to a difference in refractive index. Accordingly, the effect produced by the pattern 4 cannot be obtained.

Further, a prism 5 that is capable of focusing light by utilizing total reflection is formed, on a surface of the low refractive index layer 24 which surface faces the reflecting plate 25, so as to be uniformly formed with no space from an adjacent prism 5 on the entire surface of the low refractive index layer 24. The prism 5 extends in the lateral direction (the x-direction in FIG. 12).

The reflecting plate 25 is formed from a dielectric material multi-layer film mirror, a reflecting plate coated with silver, or a white PET resin.

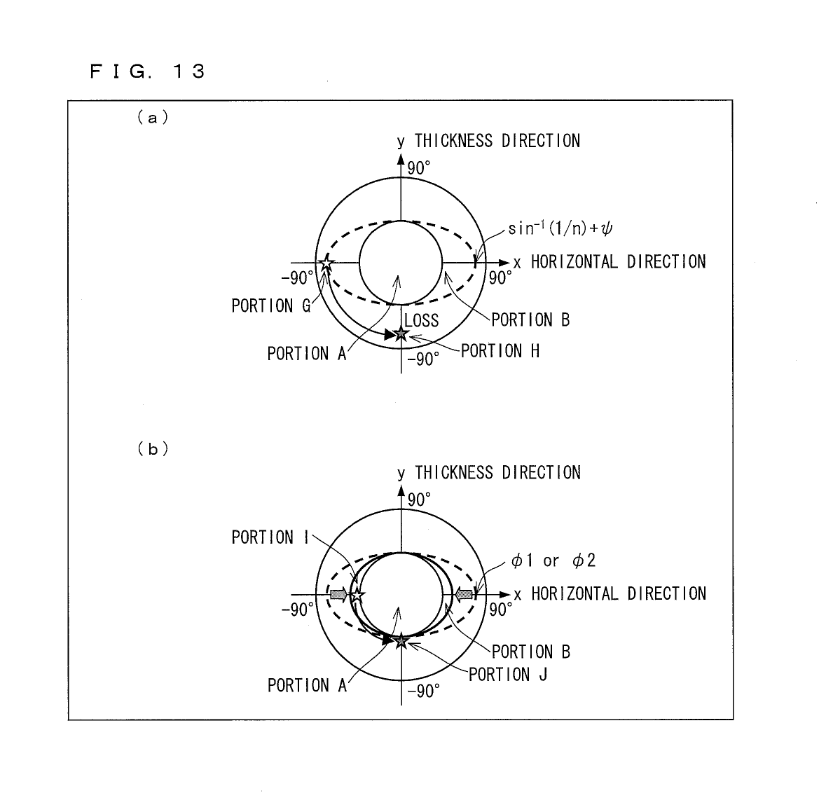

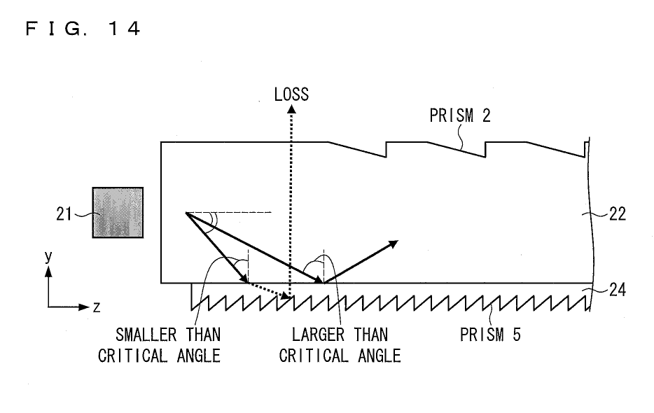

(a) and (b) of FIG. 13 each illustrate an angular distribution of light when viewed from a direction (the z-direction) vertical to the light incident surface of the light guide provided in the backlight device of the present embodiment. FIG. 14 is a side view illustrating an outline configuration of the backlight device of the present embodiment.

When light which enters the light guide 22, spread in the x-direction by the prism 1, reflected by the prism 3 so that its direction is changed enters a boundary between the light guide 22 and the low refractive index layer 24 at an angle equal to or smaller than a critical angle, the light enters the low refractive index layer 24 and therefore exits from the light exit surface side due to the prism 5. Accordingly, a light loss occurs.

In view of this, the light thus spread is focused in the z-direction by the pattern 4. This allows the light to enter the boundary between the light guide 22 and the low refractive index layer 24 at an angle equal to or larger than the critical angle, thereby reducing a light loss in the vicinity of the light sources 21.

<Method for Producing Light Guide>

With reference to FIGS. 17 through 22, the following describes a method for producing the light guide 22 of the present embodiment.

First, the light guide 22 is formed by using a thermal imprint process. Specifically, a film material 22k made of a transparent resin or the like is disposed between an upper mold 30 and a lower mold 31 as illustrated in FIG. 17. Then, the film material 22k is heated and pressed by the upper mold 30 and the lower mold 31 as illustrated in FIG. 18. Thus, the film material 22k is formed into a desired shape. Note that the desired shape means any of the above-mentioned shapes in the light guide 22.

Then, the film material 22k is detached from the upper mold 30 and the lower mold 31, and is then cooled and divided into individual pieces. Thus, the light guide 22 is obtained as illustrated in FIG. 19.

Although the light guide 22 can be formed by using injection molding instead of the imprint process, the light guide 22 can be produced by a roll-to-roll process in a case where the light guide 22 is formed with the use of the film material 22k by using the imprint process. This makes it possible to shorten a time required for the production and to reduce a production cost.

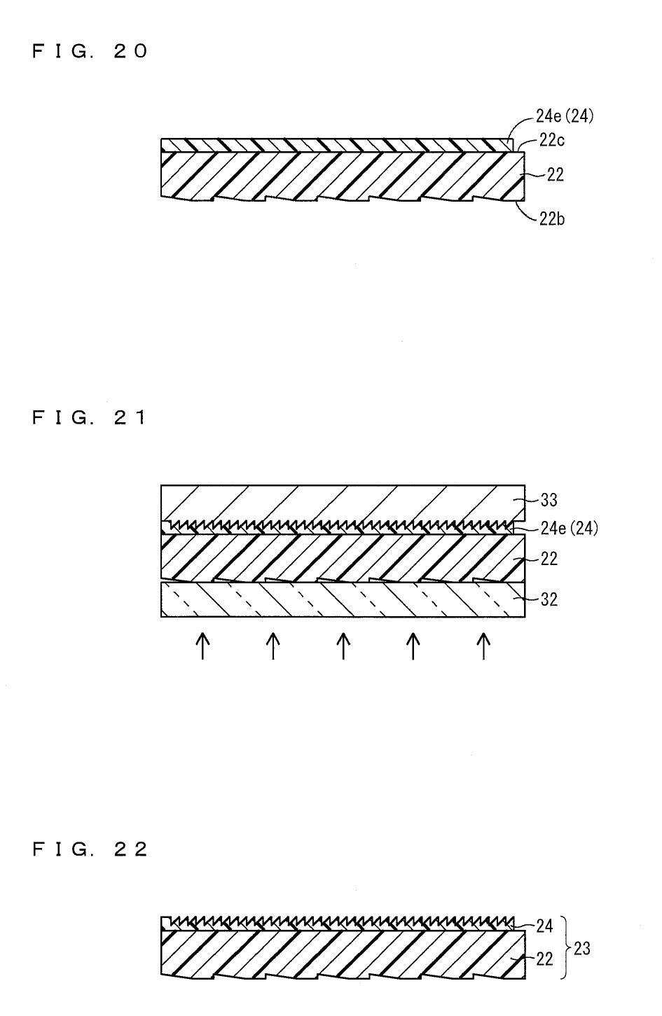

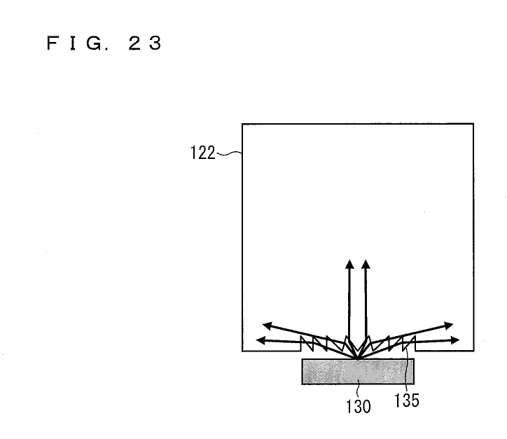

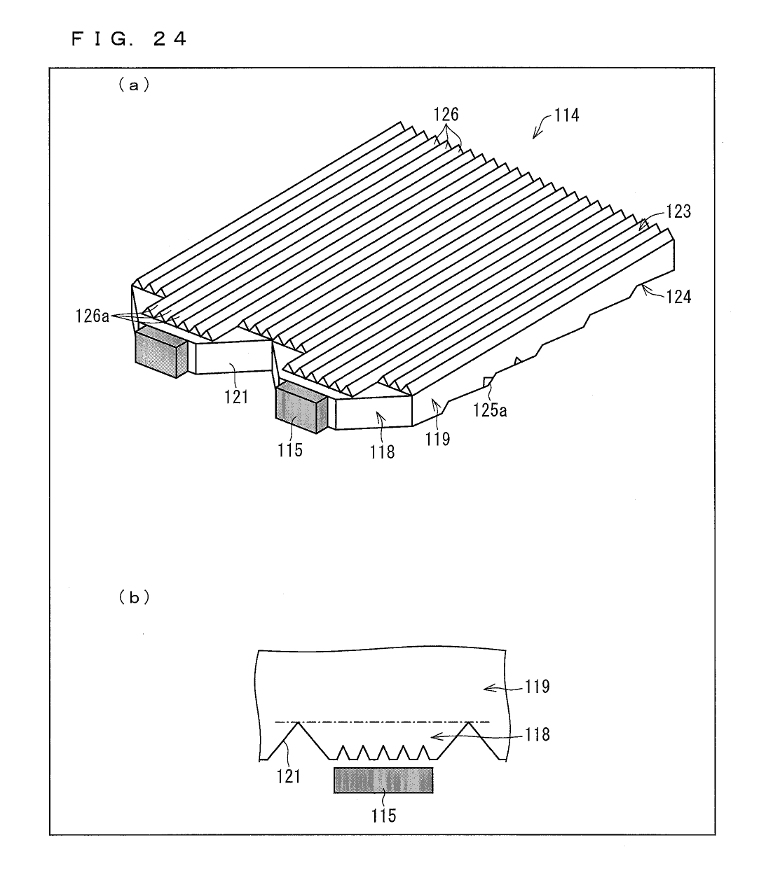

Subsequently, the low refractive index layer 24 is formed on the back surface 22c of the light guide 22 by using an imprint process utilizing UV light (ultraviolet ray). Specifically, a UV cured resin 24e made of a transparent resin is applied to the back surface 22c of the light guide 22 as illustrated in FIG. 20. Since the light guide 22 is formed so that the light exit surface 22b and the back surface 22c are substantially parallel to each other, the UV cured resin 24e can be applied so as to have a uniform thickness.

Then, the light guide 22 and the UV cured resin 24e are disposed on a quartz substrate 32, and the light guide 22 and the UV cured resin 24e are sandwiched by the quartz substrate 32 and a mold 33, as illustrated in FIG. 21. Subsequently, these members are irradiated with UV light from the quartz substrate 32 side, so that the UV cured resin 24e is cured and becomes the low refractive index layer 24.

Thus, the light guide member 23 constituted by the light guide 22 and the low refractive index layer 24 each of which has been formed into a desired shape is obtained as illustrated in FIG. 22.

In a case where the prisms 2 and 3 and the pattern 4 are formed on the light exit surface 22b of the light guide 22 and where no optical member is formed between the light guide 22 and the low refractive index layer 24, the optical members may be formed on a film material including the light guide 22 and the low refractive index layer 24 stacked on the light guide 22, by using a double-side imprint process or a one-side imprint process for each surface.

It is also possible that the processes up to the formation of the low refractive index layer 24 and the formation of the optical member are carried out by a roll-to-roll process, and then the light guide member 23 (the light guide 22 and the low refractive index layer 24) is divided into individual pieces.

### Embodiment 3

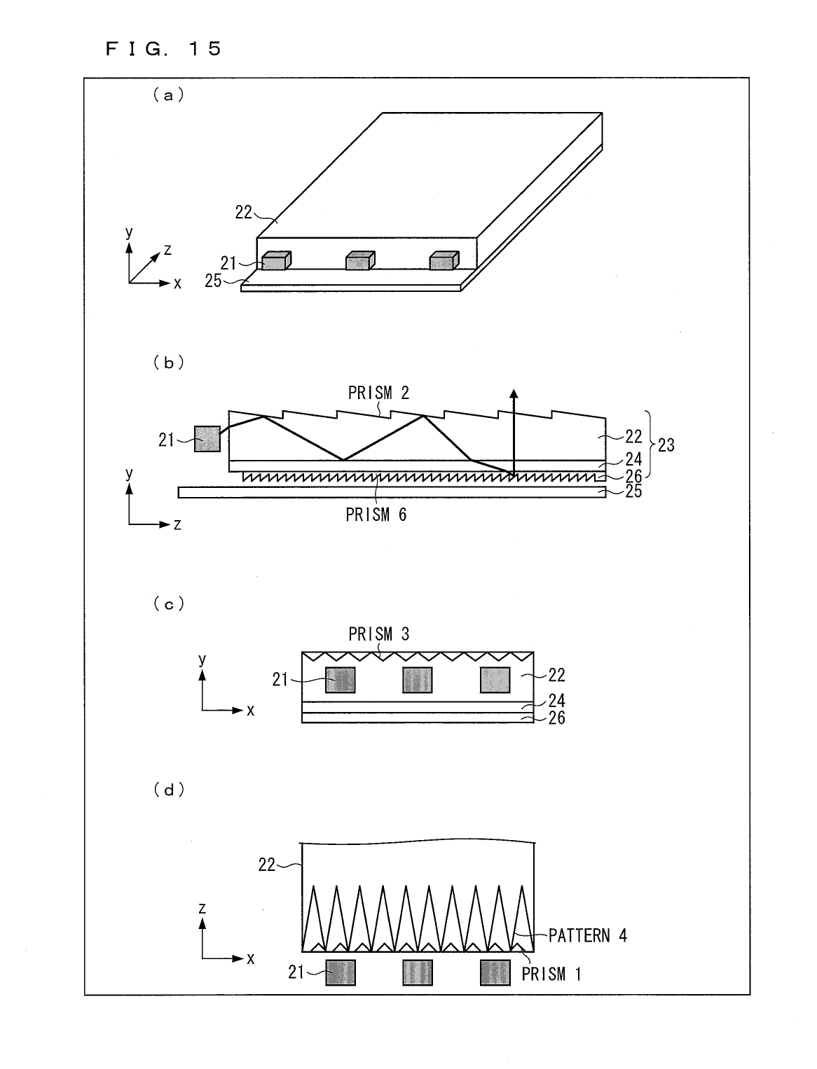

Another embodiment of the present invention concerning optical members is described below with reference to FIGS. 15 and 16. For convenience of description, members that have identical functions to those in the drawings described in Embodiment 1 are given identical reference numerals, and are not explained repeatedly.

[Specific Configuration of Light Guide and Backlight Device (Planar Lighting Device)]

(a) of FIG. 15 is a perspective view illustrating an outline configuration of a backlight device of the present embodiment, (b) and (c) of FIG. 15 are side views each illustrating an outline configuration of the backlight device of the present embodiment, and (d) of FIG. 15 is a plan view illustrating an outline configuration of the backlight device of the present embodiment.

As illustrated in (b) of FIG. 15, in the backlight device of the present embodiment, a light guide member 23 is constituted by (i) a light guide 22 which is made of a transparent material having a refractive index n1 and which has a substantially rectangular parallelepiped shape or a substantially cubic shape, (ii) a low refractive index layer 24 which is attached to a bottom surface of the light guide 22 with no air layer therebetween and which is made of a transparent material having a refractive index n2, and (iii) a prism layer which is attached to a bottom surface of the low refractive index layer 24 with no air layer therebetween and which is made of a transparent material 26 having a refractive index n3.

The refractive index n2 and the refractive index n3 satisfy n2<n3. On an entire surface of the prism layer made of the transparent material 26 which surface faces the reflecting plate 25, a prism 6 that is capable of focusing light by utilizing total reflection is formed uniformly with no space from an adjacent prism 6.

FIG. 16 is a side view illustrating an outline configuration of the backlight device of the present embodiment. When light which enters the light guide 22, spread in the x-direction by the prism 1, and reflected by the prism 3 so that its direction is changed enters a boundary between the light guide 22 and the low refractive index layer 24 at an angle equal to or smaller than a critical angle, the light enters the low refractive index layer 24 and therefore exits from the light exit surface side due to the prism 6. Accordingly, a light loss occurs.

In view of this, the light thus spread is focused in the z-direction by the pattern 4. This allows the light to enter the boundary between the light guide 22 and the low refractive index layer 24 at an angle equal to or larger than the critical angle, thereby reducing a light loss in the vicinity of the light sources 21.

### PREFERABLE MODE OF PRESENT INVENTION

The planar lighting device of the present invention is preferably arranged such that the second optical member extends in a direction parallel to the light incident surface.

According to the planar lighting device of the present invention, light entering the light guide from the end surface of the light guide is reflected by the second optical member so that a traveling direction of the light is deflected in a direction vertical to the light exit surface. This makes it possible to suppress unevenness in direction of the light emitted from the light exit surface.

The planar lighting device of the present invention is preferably arranged such that the fourth optical member has a plurality of concave parts set back into the light exit surface.

This allows the planar lighting device of the present invention to achieve a further increase in light focusing efficiency inside the light guide.

The planar lighting device of the present invention is preferably arranged such that the concave part(s) of the fourth optical member become(s) narrower from the light incident surface towards a surface of the light guide which surface faces the light incident surface when the fourth optical member is viewed from a light exit surface side.

This allows the planar lighting device of the present invention to achieve a further increase in light focusing efficiency inside the light guide.

The planar lighting device of the present invention is preferably arranged such that the concave part(s) of the fourth optical member has(have) a depth that is smaller than a difference between a thickness of the light guide and a thickness of a light exit surface of the light source.

This allows the planar lighting device of the present invention to reduce light which does not enter the light guide out of the light emitted from the light source, i.e., reduce a light loss.

The planar lighting device of the present invention is preferably arranged such that the concave part(s) of the fourth optical member has(have) a depth that is larger than a thickness of the second optical member or the third optical member formed on an identical surface to the fourth optical member.

Accordingly, in the planar lighting device of the present invention, an area of a surface for reflecting the light diffused by the first optical member, i.e., an area of the side surface of the concave part of the fourth optical member can be made sufficiently large.

The planar lighting device of the present invention is preferably arranged such that the concave parts of the fourth optical member are disposed with no space therebetween in a region of the light guide which region is irradiated with the light emitted from the light source.

Accordingly, in the planar lighting device of the present invention, an area of surfaces for reflecting the light diffused by the third optical member, i.e., an area of the side surfaces of the concave parts of the fourth optical member can be made sufficiently large.

The planar lighting device of the present invention is preferably arranged such that the concave part(s) of the fourth optical member has(have) a width smaller than a width of the light source.

This allows the planar lighting device of the present invention to achieve a further increase in light focusing efficiency inside the light guide.

The planar lighting device of the present invention is preferably arranged such that a base angle of the concave part(s) of the fourth optical member is 90°.

Accordingly, the planar lighting device of the present invention can reduce a disadvantage caused in a case where a base angle of the concave part is deviated from approximately 90°, i.e., a disadvantage such that light reflected by the fourth optical member becomes a light loss in an ineffective region.

The planar lighting device of the present invention is preferably arranged to further include a low refractive index layer between the light guide and the reflecting member, the low refractive index layer serving as a fifth optical member. That is, it is preferable that in a case where the planar lighting device of the present invention includes the fifth optical member, the planar lighting device of the present invention further includes a low refractive index layer between the light guide and the reflecting member.

This allows the planar lighting device of the present invention to achieve improved luminance and further improved light use efficiency.

The planar lighting device of the present invention is preferably arranged to further include: a low refractive index layer between the light guide and the reflecting member; and a sixth optical member between the low refractive index layer and the reflecting member, the sixth optical member being made of a transparent material.

Although a transparent material having a relatively low refractive index such as the one used as the low refractive index layer is expensive, this makes it possible to reduce the thickness of the low refractive index layer, thereby reducing a used amount of a relatively expensive transparent material having a low refractive index. Consequently, it is possible to suppress an increase in production cost.

A display device of the present invention includes the planar lighting device and a display panel.

This allows the display device of the present invention to achieve excellent luminance uniformity and light use efficiency.

[Other Matters]

A planar lighting device of the present invention may be arranged to include a light guide plate (light guide) which receives light emitted from a point light source and causes the light to be plane-emitted, the light guide plate having (i) an optical pattern formed in a part of the light incident surface of the light guide plate which part faces the light source, (ii) an optical pattern which is formed on at least one surface of the light guide plate and which extends in a direction vertical to the light entry surface, and (iii) a plurality of concave-shaped optical patterns formed on at least one surface of the light guide plate out of surfaces adjoining to the light entry surface (light incident surface) so as to be located adjacent to the light entry surface.

The planar lighting device of the present invention may be arranged such that an optical pattern that extends parallel to the light incident surface is formed on at least one surface of the light guide plate, for example.

Further, the planar lighting device of the present invention may be, for example, arranged such that the concave-shaped optical patterns formed adjacent to the light entry surface become narrower from the light entry surface towards a surface facing the light entry surface.

Further, the planar lighting device of the present invention may be, for example, arranged such that the concave-shaped optical patterns formed adjacent to the light entry surface each have a depth that is smaller than a difference between a thickness of the light guide and a thickness of a light emitting region of the point light source but is larger than a depth (height) of a prism formed on an identical surface to the concave-shaped optical patterns.

Further, the planar lighting device of the present invention may be, for example, arranged such that the concave-shaped optical patterns are disposed with no space therebetween in a region which light from the point light source enters.

Further, the planar lighting device of the present invention may be arranged such that a pitch of each of the concave-shaped optical patterns is smaller than a width of the point light source, for example.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to display devices such as mobile phones, notebook computers, televisions, digital cameras, digital photo frames, and electronic dictionaries.

### REFERENCE SIGNS LIST

1: Liquid crystal display device (display device)
10: Liquid crystal display panel (display panel)
11: AM substrate
12: Counter substrate
20: Backlight device (planar lighting device)
21: Light source
22: Light guide
22a: Light incident surface
22b: Light exit surface
22c: Back surface (surface facing light exit surface 22b)
23: light guide member
24: Low refractive index layer
25: Reflecting plate (reflecting member)
26: Transparent material

1. A planar lighting device comprising:
a light source;
a light guide having (i) a light incident surface which allows light emitted from the light source to enter the light guide, (ii) a light exit surface from which the light having entered the light guide exits, and (iii) a back surface facing the light exit surface; and
a reflecting member which is disposed so as to face the back surface, the reflecting member reflecting the light emitted from the back surface so that the light enters the light guide again,
the light guide comprising:
a first optical member formed on the light incident surface, the first optical member diffusing the light emitted from the light source towards an inside of the light guide;
a second optical member formed on the light exit surface or the back surface, the second optical member changing an angle of the light inside the light guide;
a third optical member formed on the light exit surface or the back surface, the third optical member diffusing the light inside the light guide; and
a fourth optical member formed on the light exit surface or the back surface so as to be close to the light incident surface, the fourth optical member focusing, inside the light guide, the light diffused by the first optical member,
the fourth optical member having a concave part set back into the light exit surface or the back surface.

2. The planar lighting device according to claim 1, wherein the second optical member extends in a direction parallel to the light incident surface.

3. The planar lighting device according to claim 1, wherein the fourth optical member has a plurality of concave parts set back into the light exit surface.

4. The planar lighting device according to claim 1, wherein the concave part(s) of the fourth optical member become(s) narrower from the light incident surface towards a surface of the light guide which surface faces the light incident surface when the fourth optical member is viewed from a light exit surface side.

5. The planar lighting device according to claim 1, wherein the concave part(s) of the fourth optical member has(have) a depth that is smaller than a difference between a thickness of the light guide and a thickness of a light exit surface of the light source.

6. The planar lighting device according to claim 5, wherein the concave part(s) of the fourth optical member has(have) a depth that is larger than a thickness of the second optical member or the third optical member formed on an identical surface to the fourth optical member.

7. The planar lighting device according to claim 3, wherein the concave parts of the fourth optical member are disposed with no space therebetween in a region of the light guide which region is irradiated with the light emitted from the light source.

8. The planar lighting device according to claim 1, wherein the concave part(s) of the fourth optical member has(have) a width smaller than a width of the light source.

9. The planar lighting device according to claim 1, wherein a base angle of the concave part(s) of the fourth optical member is 90°.

10. The planar lighting device according to claim 1, further comprising a low refractive index layer between the light guide and the reflecting member,
the low refractive index layer serving as a fifth optical member.

11. The planar lighting device according to claim 1, further comprising:
a low refractive index layer between the light guide and the reflecting member; and
a sixth optical member between the low refractive index layer and the reflecting member, the sixth optical member being made of a transparent material.

12. A display device comprising:
a planar lighting device as set forth in claim 1; and
a display panel.
